(19) United States
(12) Patent Application Publication
(10) Pub. No.: US 2001/0046657 A1
(43) Pub. Date: Nov. 29, 2001

(54) Personal introduction system

(76) Inventor: Gregg Randall Dorn, Centreville, VA (US)

Correspondence Address: Gregg Dorn, 6338 Shirey Lane, Centreville, VA, 20121, US

(21) Appl. No.: 09/771,990

(22) Filed: Jan. 30, 2001

Related U.S. Application Data
(60) Provisional application No. 60/179,120, filed on Jan. 31, 2000.
(60) Provisional application No. 60/200,252, filed on Apr. 28, 2000.

(51) Int. Cl. G09B 19/00

(52) U.S. Cl. 434/118

(57) ABSTRACT

The invention provides a personal introduction system for participating users that allows users to gain access to information about other users after an initial contact. The system according to the invention may also be configured to allow users to gain access to only those other users for which a mutual attraction is indicated. The invention allows at least two persons coming into contact with one another to be made aware of a mutual attraction, and to be given a mechanism for establishing contact with on another once the mutual attraction is confirmed by the introduction system.

### BACKGROUND OF THE INVENTION

1. Field of Invention

The invention relates generally to a communication system. More particularly, the invention provides an integrated communications system allowing interested persons to gain access to additional information about other persons after an initial contact.

2. Description of the Related Art

Two people can meet in a variety of different forums and circumstances. After an initial meeting, two people may desire further interaction. There can be many different reasons why people desire further interaction. For example, in a business environment people may meet at a professional convention, retreat, or business meeting. Further business interaction may be desired in order to pursue a professional relationship, such as buyer-seller, recruiter-candidate or producer-consumer. The most common method for exchanging professional information is the business card. A typical business card may include a person's name, business address and telephone number. Thus, while business cards do convey at least basic information about a person, their limited size restricts how much information may be provided. In addition, business cards must be regularly updated when personal information changes, are easily lost, and are otherwise difficult to keep track of.

People also meet new people or desire to meet new people for social reasons. Traditional venues for meeting people, such as bars and clubs may be less desirable for many people, including older singles, a demographic that had increased significantly in recent years. Many people would prefer to meet others during their normal daily activities. However, many people find it difficult to start conversation with a stranger. Even if one does strike up a conversation with a stranger, it may be difficult to ascertain whether that person is interested in pursuing further social contact. Many people are also hesitant to start a conversation with a stranger for fear of rejection. Even if one does strike up a conversation with a stranger, it may be difficult to determine whether there are any mutual interests.

The success of alternative forums for people to meet, such as dating services and chat rooms illustrates the market for new and creative ways for people to meet and pursue social relations.

### SUMMARY OF THE INVENTION

Thus, the system and method according to the invention solves the problems with conventional introduction mechanisms. The system and method according to the invention provides a personal introduction system that allows users to access information about persons they have come into contact with.

For example, according to one embodiment, the invention provides a system whereby two people meeting at a business convention can later access information about one another on-line without having actually physically exchanged a business card, phone number or any other information.

In another embodiment, the invention also provides a mechanism for two persons to follow up on an initial encounter and determine whether a mutual attraction exists. By using the invention, a person has the ability to:

1. Find out if a person they encounter (who is also using the invention) matches basic personal criteria;

2. Register interest in that person;

3. Find out that the other person is also interested in them (a mutual attraction);

4. Know that if the attraction is not mutual, their interest is never revealed to the other person.; and

5. Establish communication with the person, once a mutual attraction has been indicated.

Thus, it is an object of the invention to provide a system and method allowing a first user who meets other users to have access to a database store providing information about all of the users that the first user has come into contact with. The available information may include, but is not limited to names, addresses, business names and addresses, education, business objectives and references. In addition, the database may provide further informational links allowing users to access even more information using the World Wide Web (“WWW”).

It is a further object of the invention to provide a system and method that allows persons coming into contact with one another to register an interest in pursuing additional social interaction. According to one embodiment of the invention, further social interaction is only possible if both parties express a mutual interest in one another. This eliminates the possibility of facing public rejection. When mutual interest is indicated, the invention provides a common database allowing communication between the two interested parties.

According to another object of the invention, a person wishing to meet other people attains permission to access a database store, attains a transceiver and a personal identification number. When the user subscribes, he or she provides basic personal information. The personal information is kept in complete confidence by the service and can be as limited or extensive as the individual desires. Only the person's picture is required to be publicly linked to the personal identification code assigned to them. After receiving the transceiver, a user enters data into the device via a user interface, which is transferred via a hardware interface. The data consists of items such as the person's identification number, and other information, such as professional information (company, position, expertise) or personal information (sex, age, etc). The user then carries the transceiver with them whenever they desire. As the user's own transceiver comes within range of other transceivers throughout the day, ID numbers and information are exchanged. It is important to note that the transceiver may be configured to include a user's personal and social preferences and thus, not store ID numbers of other users if the characteristics broadcast by another user's transceiver does not fall within his or her preferences. Based upon the settings/preferences loaded into each device, some ID numbers would be stored, while other would be filtered out and ignored.

If a first user feels as though he or she met or saw someone (i.e., a second user) that they believe may be mutually interested, they can use the Internet service to confirm that interest, and establish contact with them. The first user would download all ID numbers stored in their transceiver onto their personal computer, where they in turn would be uploaded to the Internet service. The service would provide the pictures associated to all ID numbers that have been collected by their transceiver. If the second user is also using the service, they will find the picture of that person. Once they have found the person's picture, they can “tag” the ID number associated to the picture to indicate that they are interested. At this point no personal information is exchanged. The service simply registers the interest. If by the same process, the second user notifies the service of interest in the first user, the service now has a match. The service can then notify both people of the mutual interest. The two users now have the option to authorize the service to share personal information (i.e. interests), convey greetings, or perform any other type of correspondence the users desire. This communication through the service promotes continued security, because neither person has to reveal phone numbers, email addresses, regular addresses, or even real names until they feel secure to do so.

The objects of the invention as described herein are accomplished by providing an introduction system for participating users that includes at least one transceiver capable of broadcasting and receiving data from a plurality of other transceivers; a user interface; a hardware interface for exchanging data between the at least one transceiver and the user interface; and a database accessible by the user interface. The database is accessible by all of the users and includes information about users, including business/professional and/or social information. The transceivers may also include user ID information, user personal information, as well as, a user's social preferences.

### BRIEF DESCRIPTION OF THE DRAWINGS

FIG. 1 is a functional illustration of the introduction system according to an embodiment of the invention;

FIG. 2 is a functional illustration of the introduction system according to another embodiment of the invention;

FIG. 3 is a functional diagram of a transceiver component in accordance with an embodiment of the invention;

FIG. 4 is a functional diagram of a hardware interface component in accordance with an embodiment of the invention;

FIG. 5 is a functional diagram of a transceiver component according to another embodiment of the invention;

FIG. 6 is a flow chart illustrating a process according to an embodiment of the invention;

FIG. 7 continues the process shown in FIG. 6;

FIG. 8 is sequential illustration of the operating modes of the transceiver component according to an embodiment of the invention; and

FIG. 9 is a schematic drawing of the transceiver component according to an embodiment of the invention.

### DETAILED DESCRIPTION OF PREFERRED EMBODIMENTS

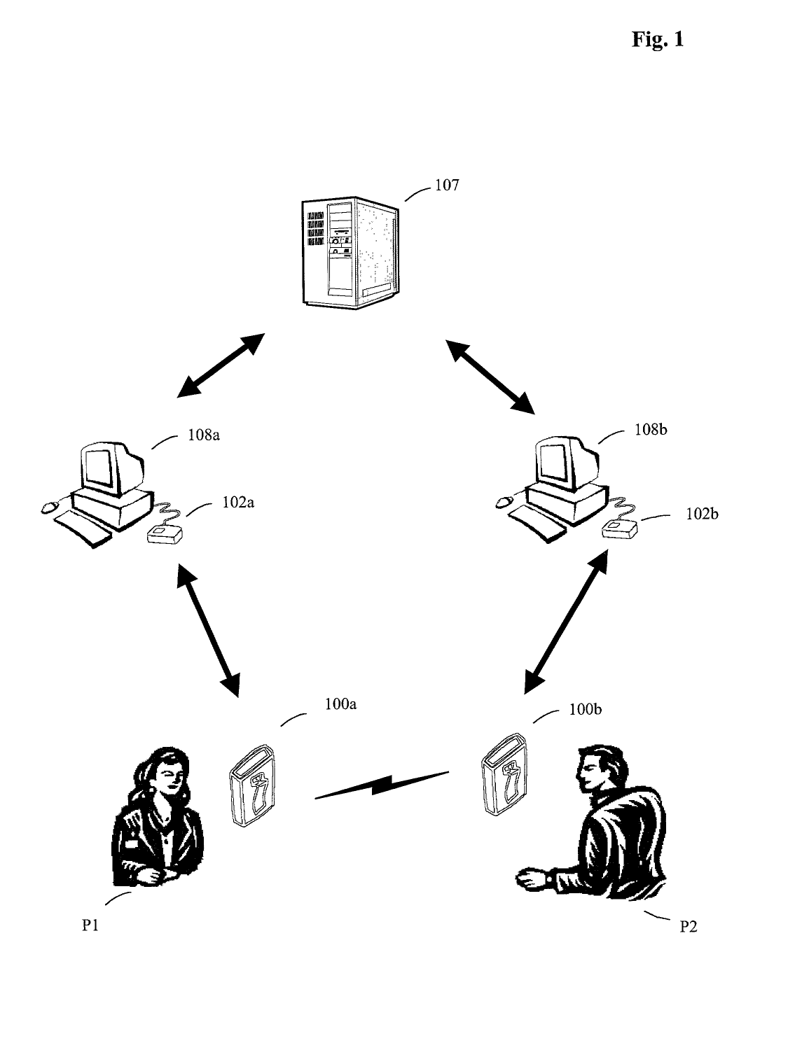

FIG. 1 illustrates the personal introduction system according to an embodiment of the invention. A user P1 carries a transceiver 100a, and a user P2 carries a transceiver 100b. Users P1 and P2 may share a brief encounter during normal daily life activities or during an organized gathering. The transceivers 100a and 100b, receive data broadcast from the other. The characteristics broadcast by the transceiver 100a match the preferences of the transceiver 100b, so the transceiver 100b stores an ID number associated with the transceiver 100a. Likewise, the characteristics broadcast by the transceiver 100b match the preferences of the transceiver 100a, so the transceiver 100a stores an ID number associated with the transceiver 100b. Later, the user P1 uploads any captured ID numbers to her user interface 108a (in this case a personal computer), via a hardware interface 102a, and the user P2 uploads any captured ID numbers to his the user interface 108b (also a personal computer), via a hardware interface 102b. The user P1 uses the user interface 108a to connect to a common database store 107, and uploads the captured ID numbers.

The database store 107 sends back to the computer 108a pictures of the users assigned to the ID numbers. One of these pictures will be of the user P2. The user P1 decides whether she would like to follow up on the initial encounter with the user P2, so she registers with the data store 107 interest in the user P2. In a similar fashion, the user P2 uses the user interface 108b to connect to the common database store 107, and uploads the captured ID numbers. The database store 107 sends back to the computer 108b pictures of the users assigned to the ID numbers. One of these pictures will be of the user P1. The user P2, after uploading his captured ID numbers, also decides he would like to follow up on the initial encounter with user P1, so he registers with the data store 107 interest in user P1. At this point both user P1 and P2 have registered interest in each other, so the database store will indicate to P1 and P2 of the mutual attraction via user interface 108a and 108b respectively. The database store 107 then provides the mechanism for the users P1 and P2 to correspond with each other through the database store 107 using their respective user interfaces 108a and 108b.

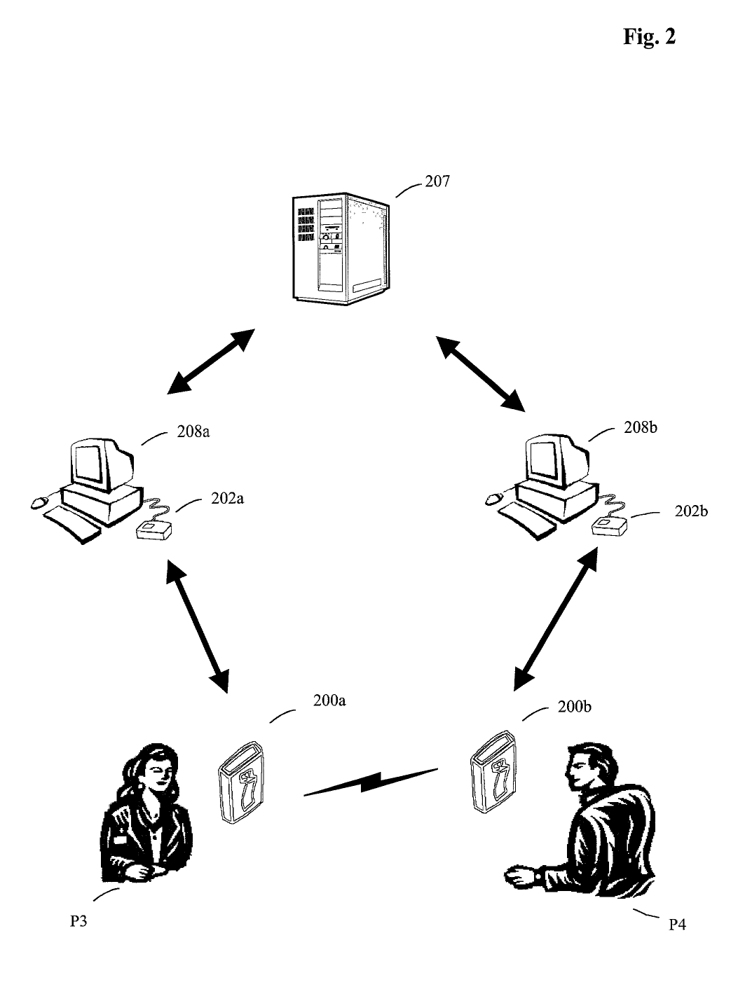

FIG. 2 illustrates the personal introduction system according to another embodiment of the invention. In FIG. 2, a user P3 carries a transceiver 200a, and a user P4 carries a transceiver 200b. The users P3 and P4 share a brief encounter during a business event, such as a convention. The transceivers 200a and 200b, receive data broadcast from one another. Later, user P3 uploads any captured ID numbers to her user interface 208a (in this case a personal computer), via her hardware interface 202a and user P4 uploads any captured ID numbers to his user interface 208b (also a personal computer), via his hardware interface 202b. User P3 uses user interface 208a to connect to a common database store 207, and uploads captured ID numbers.

The database store 207 sends back to the computer 208a pictures of the users assigned to the ID numbers, and basic information pertaining to their business offerings. One of these sets of pictures and information will be of user P4. User P3, noting offerings similar to her needs, decides she would like to follow up on the initial encounter with user P4, so she registers with the data store 207 interest in user P4. User P4, after uploading his captured ID numbers, also decides he would like to follow up on the initial encounter with user P3, so he registers with the data store 207 interest in user P3. At this point both user P3 and P4 have registered interest in each other, so the database store will indicate to P3 and P4 of a mutual attraction via user interface 208a and 208b respectively. The database store 207 then provides the means for users P3 and P4 to correspond with each other through the database store 207 using their respective user interfaces 208a and 208b.

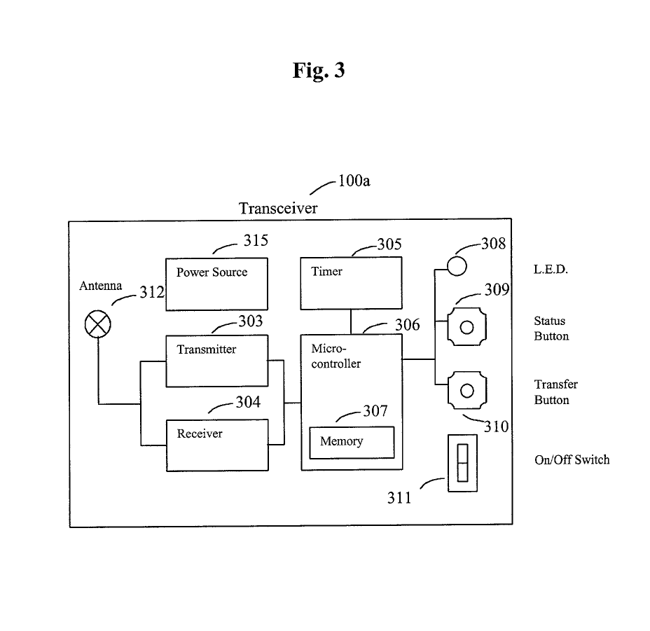

FIG. 3 illustrates the components of transceiver 100a according to the embodiment shown in FIG. 1. The transceiver is powered by a power source 315 consisting of a battery connected to a voltage converter circuit. The power source 315 includes a regulated voltage adequate to power all the components in the transceiver. An antenna 312 is connected to both the transmitter 303 and the receiver 304. The transmitter 303 and receiver 304 are interfaced to a microcontroller 306 such that the microcontroller 306 can broadcast and receive data from other transceivers. When data is received by the receiver 304, the data is sent to the microcontroller 306. The microcontroller 306 decodes the received data into a personal ID number and personal characteristics. The microcontroller 306 also performs data integrity checking to insure that data was received accurately. The microcontroller 306 compares the received personal characteristics against preferences stored in the microcontroller's 306 memory 307. If the characteristics match the preferences, the microcontroller will store the received personal ID number into the microcontroller's memory 307. A plurality of ID numbers can be stored in the memory 307. The timer 305 is logic circuit configured to generate an astable signal to the microcontroller 306 so that the microcontroller 306 receives a pulse once every few seconds. The microcontroller 306 will use the pulse as a basis to repeatedly turn on or off the receiver 304, and to transmit data via the transmitter 305. In between pulses, the microcontroller 306 puts itself into an idle mode, which conserves power. The on/off switch 311 is used to set the transceiver into a maximized power saving mode. When set to the “off” position, the microcontroller 306 will turn off the receiver 304, and put itself into hibernate mode.

In hibernate mode, memory 307 contents are maintained, but all other functions are shut down. The hibernate mode is more energy saving than the idle mode. When the on/off switch 311 is set to the “on” position, the microcontroller 306 returns to idle mode. The status button 309, is a momentary-action button, that when pressed by a user, will signal the microcontroller 306 to check if any ID numbers have been stored since the last time the status button 309 was pressed. If ID numbers have been stored, the microcontroller 306 will flash the L.E.D. 308 (Light Emitting Diode) twice. If no ID numbers have been stored, the microcontroller 306 will flash the L.E.D. 308 once. The fact that the L.E.D. 8 will flash in either condition also serves to inform the user that the transceiver 100a is still working. If L.E.D. 308 does not flash, either the transceiver 100a is broken, or the power source 319 has been exhausted. The transfer button 310 is used to initiate a data transfer between the transceiver 100a and the hardware interface 102a that is depicted in FIG. 1. The data transferred will be personal characteristics and preferences being sent from the user interface 108a (also depicted in FIG. 1) to the transceiver 100a, and captured ID numbers being sent from the transceiver 100a to the user interface 108a.

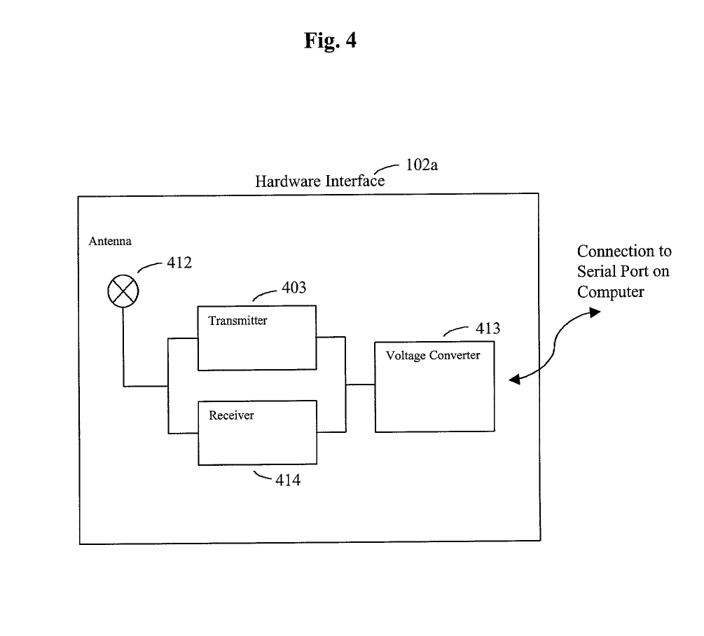

FIG. 4 illustrates the hardware interface 102a according to the embodiment shown in FIG. 1. The hardware interface 402 utilizes an antenna 412, receiver 414, and transmitter 403 that are identical to those used in the transceiver 100a. Through these like components, a communication means is possible. The hardware interface 102a attaches to the user interface 108a via a standard RS232 serial port. The hardware interface 102a draws power from the serial port to which it is attached. An antenna 412 is connected to both the transmitter 403 and the receiver 414. The transmitter 403 and receiver 414 connect to a voltage converting circuit 413, which in turn connects to the serial port of the user interface 108a. The voltage converter 413 permits, if necessary, data from the transmitter and receiver to converted from a 0 to +5 volt range to the RS232 port's −12 to +12 volt range. Software on the user interface 108a will decode all data received from the receiver 414, and encode all data to be transmitted by the transmitter 403.

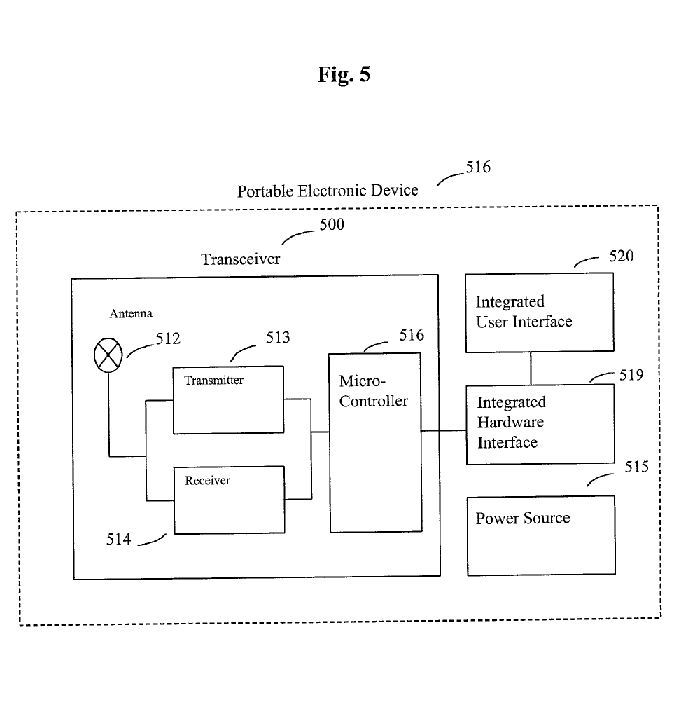

FIG. 5 illustrates another embodiment in which the transceiver 100a, hardware interface 102a, and user interface 108a. as shown in FIG. 1 are now contained in one unit, in this case transceiver 500. In this variation, the transmitter 513, receiver 514, and microcontroller 516 are integrated directly to a portable personal electronic device 516 via an integrated hardware interface 519. The electronic device 516 may be a cell phone, pager, Personal Data Assistant, personal computer, or any other portable device of similar capabilities, and could provide a wireless connection to the database 517. An integrated user interface 520 is provided by the electronic device 516. In this embodiment, all components of the invention excluding the database store 107 (seen in FIG. 1) are in one package.

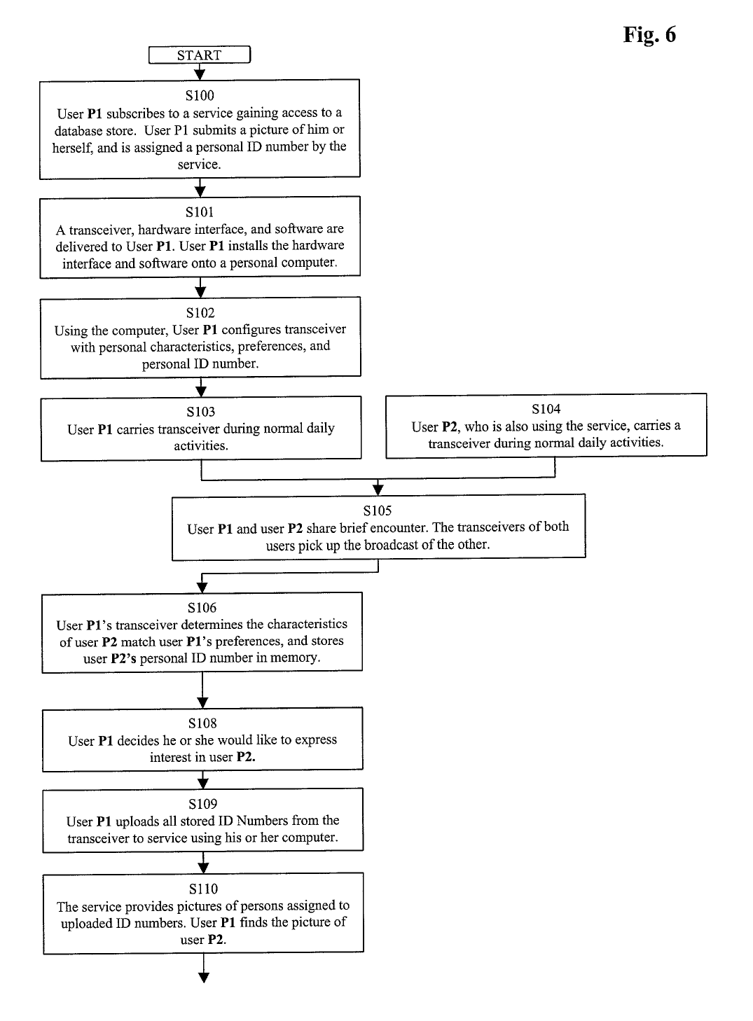

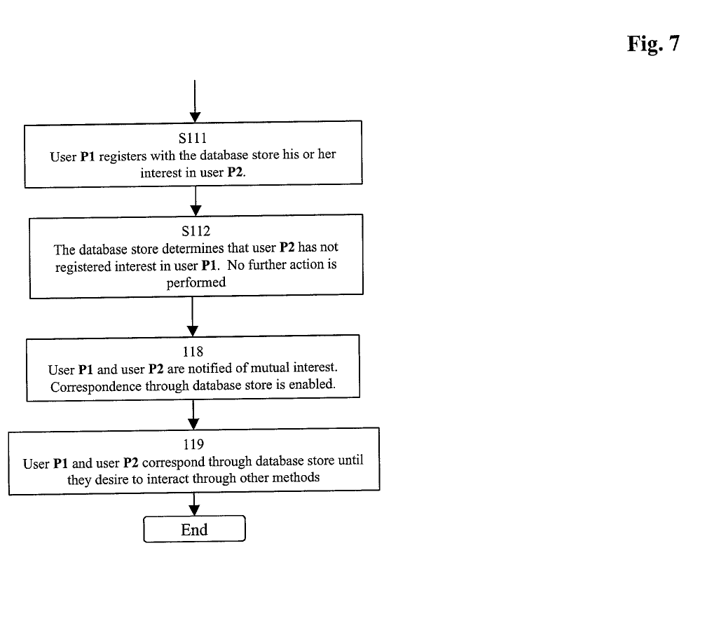

FIG. 6 and FIG. 7 show the process according to an embodiment of the invention as depicted in FIG. 1. FIG. 7 is a continuation of the flow chart in FIG. 6. In the step S100, two users subscribe to a service that provides access to a common database (107 of FIG. 1). Then, through the subsequent steps S101-S119, the two users are able to establish contact after an initial encounter. The steps S100-S119 are detailed below.

The process begins with step S100. In step S100, a first user P1 subscribes to a service, thus gaining access to a database store. The user P1 also submits a photograph of him or herself and is assigned a user ID number. The process then moves to step S101.

In step S101, the user P1 receives a transceiver, hardware interface, and software from the services, and installs the hardware interface and software onto a personal computer. The process then goes to step S102. In step S102, Using the computer, user P1 configures the transceiver with his or her personal characteristics, preferences, and personal ID number. The process then moves to S103. In step S103, the user P1 carries the transceiver during the course of a social function, meeting, conversation, or even during normal activities. The process them moves to step S104.

Step S104 illustrates a second user P2 who has followed steps parallel to steps S100-S103 as followed by the user P1. Thus, in step S104, the user P2 has also subscribed to the service and is carrying a transceiver. The process then moves to step S105. In step S105, the users P1 and P2 encounter one another. Each transceiver picks up the broadcast of the other. The process then moves to step S106.

In step S106, the user P1's transceiver determines that user P2's characteristics as broadcast by user P2's transceiver match user P1's preferences as defined in user P1's transceiver. User P1's transceiver stores the user P2's personal ID number in memory. The process then moves to step S108. In step S108, the user P1 decides he or she would like to express interest in user P2. The process the moves to step S109. In step S109, the user P1 uploads all stored ID numbers from the transceiver to the database store using the computer. The process them moves to step S110.

In step S110, the database store provides pictures of all persons assigned to the uploaded ID numbers. Thus, the user P1 can view the pictures corresponding to all the uploaded ID numbers. The process then moves to step S111.

In step S111, the user P1 registers with the services his or her interest in user P2. The process then goes to step S112. In step S112, the database store determines whether user P2 has registered an interest in user P1. If user P2 has not expressed interest, the process ends at step S112. Otherwise the process moves to step S118 since both user P1 and P2 have expressed mutual interest in each other.

In step S118, both users are notified of their respective mutual interest in one another. The process then moves to step S119. In step S119, the users P1 and P2 are able to communicate via the database store. They may do this as long as desired, at least until they agree to other communication means.

It should be noted that the process described above in conjunction with the FIG. 6 and FIG. 7 described the process from the viewpoint of the first user. However, a similar process also occurs from the viewpoint of a second user.

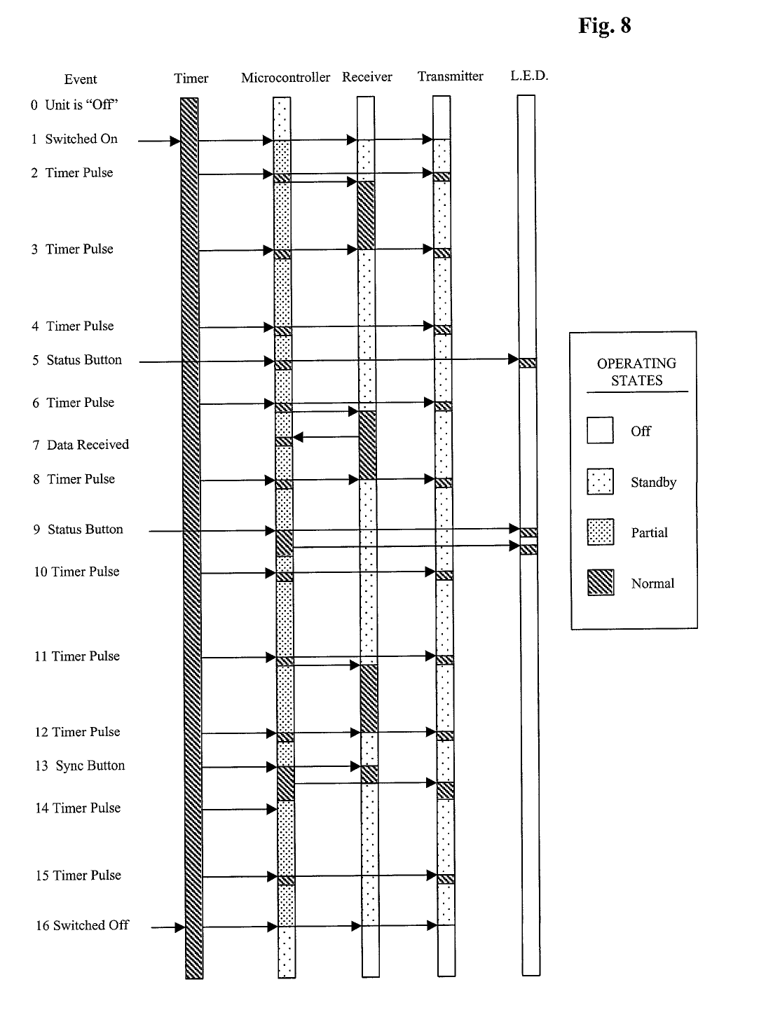

FIG. 8 illustrates the operating method sequence of the transceiver 100a (as depicted in FIG. 3). The illustration demonstrates a method of operation so that power consumption of the entire unit is minimized. The sequence depicted is organized by events starting with Event 0, in which the transceiver is turned off. Event 1 through Event 16, then occur in chronological order, with Event 16 being the last. The primary theory of operation is that all components do not need to be on continuously. The method utilizes the interrupt-handling capabilities of the microcontroller 306 to allow components within the transceiver 100a to be enabled only when needed. The microcontroller 306, spends most of its time in an idle state waiting for an interrupt signal. An interrupt will come in the form of a signal from the timer circuit 305, a pressed status button 309, a pressed transfer button 310, or a data-being-received signal from the receiver 334. The only unit that stays in a normal operating mode at all times is the timer circuit 305. The timer circuit 305 is the “heart beat” to which the transceiver 303 will broadcast data, and turn on or off the receiver 304. According to one embodiment of the invention, the timer circuit 305 is set to signal the microcontroller 306 approximately every 4 seconds. At each signal, the microcontroller 306 is activated, which broadcasts data via the transmitter 303 and, based on how the transceiver 100a is configured, turn on or off the receiver 304. Once the microcontroller 306 has finished these tasks, it puts itself back into idle mode. If the transceiver 100a is turned off, the receiver 304 is turned off (if it is on), and the microcontroller 306 is put into hibernate mode, in which it will no longer recognize interrupts. In this state only the contents of the microcontroller's 306 memory is preserved, and no attempts to receive or broadcast data is made.

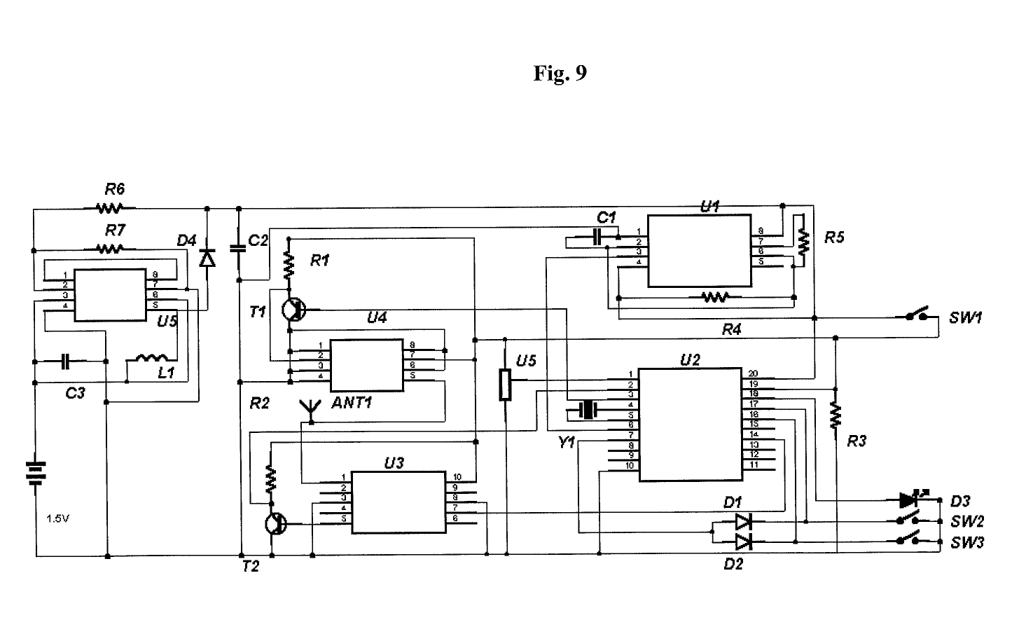

FIG. 9 is a circuit diagram of transceiver 100a (as depicted in FIG. 1) in its one embodiment as depicted in FIG. 1. Components show are defined as follows:

U1 Maxim ICM7555IPA (Timer)

U2 Atmel AT89C2051-12PC (Microcontroller)

U3 Linx RXM-418-LC (Receiver Module)

U4 Linx TXM-418-LC (Transmitter Module)

U5 Microchip MCP101-270DI/TO-92 (Microcontroller Supervisor)

U6 Linear Technologies LT1610 Step-up Converter

T1, T2, T3 MPS2222A (Transistor)

C1, C2, C3 22 uf Capacitor

R1, R2 100K Resistor

R3 220 ohm Resistor

R4 330K Resistor

R5 1.7K Resistor

R6 1M Resistor

R7 681K Resistor

D1, D2 General Purpose Diode

D3 Low Drain Light Emitting Diode

D4 0.5A, 20V Schottky Diode

SW1 SPST Switch

SW2, SW3 Contact Switch

Y1 12 Mhz Quartz Crystal

ANT1 Wire Antenna

L1 TOKO TKS2524CT 4.7 uf Inductor

It is important to note that the transceiver show in FIG. 9 is illustrative of one embodiment of the invention, but that other configurations are possible and contemplated by the disclosure herein.

While specific embodiments of the invention have been described herein, it will be apparent to those skilled in the art that various modifications may be made without departing from the spirit and scope of the invention.

I claim:

1. An introduction system for participating users, comprising:
at least one transceiver capable of broadcasting and receiving data from a plurality of other transceivers;
a user interface;
a hardware interface for exchanging data between the at least one transceiver and the user interface;
and a database accessible by the user interface.

2. The introduction system according to claim 1, wherein the at least one transceiver includes a first memory location storing the data.

3. The introduction system according to claim 1, wherein the data includes a user ID and a participating user's personal characteristics.

4. The introduction system according to claim 1, wherein the data includes a participating user's personal preferences.

5. The introduction system according to claim 3, wherein the personal characteristics include at least one of age, sex, social habits and hobbies.

6. The introduction system according to claim 4, wherein the personal preferences include at least one of age, sex, social habits and hobbies.

7. The introduction system according to claim 1, wherein the transceiver utilizes radio waves to transmit and receive data.

8. The introduction system according to claim 1, wherein the at least one transceiver broadcasts and receives data from other transceivers only when the at least one transceiver is in close proximity to the other transceivers.

9. The introduction system according to claim 1, wherein the hardware interface exchanges data with the at least one transceiver via at least one of radio, light, infrared and direct wire connect.

10. The introduction system according to claim 1, wherein the user interface is at least one of a computer, a cell phone, a pager, and a Personal Digital Assistant, having the capability of accessing the database through a wireless connection.

11. The introduction system according to claim 1, wherein participating users enter at least one of personal preferences or personal characteristics into the user interface.

12. The introduction system according to claim 1, wherein the database allows the participating users to communicate.

13. The introduction system according to claim 1, wherein the participating users can communicate only if a mutual interest is detected.

14. The introduction system according to claim 1, wherein the database is a via the Internet.

15. The introduction system according to claim 1, wherein the transceiver minimizes power consumption by utilizing an astable signal to turn on and off components.

16. A method for facilitating personal introductions, comprising the steps of:
broadcasting data from at least one transceiver;
receiving data from at least one transceiver;
storing the data in a memory store located in the transceiver; and
accessing information based upon the stored data.

17. The method according to claim 16, further comprising the steps of:
determining the existence of a mutual interest between more than one user; and
permitting access to personal information base upon the mutual interest.

18. The method according to claim 16, wherein the data includes a personal identification number.
